(19) United States
(12) Patent Application Publication
(10) Pub. No.: US 2010/0104118 A1
(43) Pub. Date: Apr. 29, 2010

(54) EARPIECE BASED BINAURAL SOUND CAPTURING AND PLAYBACK

(76) Inventors: Sherin Sasidharan, Bangalore (IN); Narendran Melithil Rajan, Bangalore (IN); Phanish Srinivasa Rao Hanagal, Bangalore (IN)

Correspondence Address: TEXAS INSTRUMENTS INCORPORATED, P O BOX 655474, M/S 3999, DALLAS, TX, 75265, US

(21) Appl. No.: 12/256,474

(22) Filed: Oct. 23, 2008

(51) Int. Cl. H04R 5/02

(52) U.S. Cl. 381/309

(57) ABSTRACT

Methods and systems of earpiece based binaural sound capturing and playback are disclosed. In one embodiment, a method for recording and playback of a binaural sound includes receiving a record command for a binaural sound, and recording electrical data which correspond to the binaural sound captured through an associated binaural sound capturing system. Further, the associated binaural sound capturing system includes two earpieces for a right ear and a left ear for a user. Each of the two earpieces includes a housing and a speaker embedded in the housing facing an inner ear of the user. In addition, the each of the two ear pieces also includes a microphone embedded in the housing at an ear canal of the user for converting the binaural sound received by the ear canal to the electrical data. Furthermore, the method includes playing back the electrical data in response to a playback command.

### FIELD OF TECHNOLOGY

Embodiments of the present invention relate to the field of electronics. More particularly, embodiments of the present invention relate to a binaural recording technique.

### BACKGROUND

Some of today cellular phones or entertainment devices have a capability to capture and playback sounds and images. For example, a user may use his or her cellular phone to record an event, such as a birthday party or a picnic, for a later playback. In such a case, the sounds associated with the event may be captured using a microphone embedded in the cellular phone or entertainment devices, where the sounds captured via the microphone are often different from sounds heard by the user during the event.

Such differences may be due to the fact that the position of the microphone in the cellular phone, which is used to record the sounds, being located in a different position than the positions of the user's ears. In addition, the user's ears as well as the user's torso process (e.g., filter) the sounds differently than the microphone in the cellular phones. Accordingly, directionalities or distant feels of the sounds processed by the microphone may not be same as those heard by the user at the time of recording. Therefore, when the captured sounds are played back, the user may find them sounding very different from what the user had heard during the event.

### SUMMARY

Methods and systems of earpiece based binaural sound capturing and playback is disclosed. In one aspect, a binaural sound capturing device includes two earpieces for a right ear and a left ear for a user, with each of the two earpieces including a housing, a speaker embedded in the housing facing an inner ear of the user, and a microphone embedded in the housing at the start of the user's ear canal for converting a sound received by the outer ear to electrical data. Further, the electrical data are stored to an external storage device for a playback of the electrical data with a binaural effect.

In another aspect, a binaural sound recording and playback system includes a storage module for recording electrical data captured by a binaural sound capturing device, and a playback module for playing back the electrical data, where the binaural capturing device is described above.

In yet another aspect, a method for recording and playback of a binaural sound includes receiving a record command for the binaural sound, and recording electrical data which correspond to the binaural sound processed through an associated binaural sound capturing device as described above.

The methods and systems disclosed herein may be implemented by any means for achieving various aspects, and may be executed in a form of a machine readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Embodiments of the present invention are illustrated by way of examples and not limited to the figures of the accompanying drawings, in which like references indicate similar elements and in which:

FIG. 1A illustrates a schematic diagram of an exemplary binaural sound capturing device communicating with a recording and playback system via a wire, according to one embodiment.

FIG. 1B illustrates a schematic diagram of an exemplary binaural sound capturing device wirelessly communicating with a recording and playback system, according to one embodiment.

FIG. 2A is a block diagram of an exemplary binaural sound capturing device, according to one embodiment.

FIG. 2B is a block diagram of another exemplary binaural sound capturing device, according to one embodiment.

FIG. 2C illustrates an exemplary earpiece of the binaural sound capturing device of FIG. 1A worn by a user, according to one embodiment.

FIG. 3 is a block diagram of an exemplary binaural sound recording and playback device, according to one embodiment.

FIG. 4 is a process flow chart of an exemplary method for storing a binaural sound captured by a binaural sound capturing system, according to one embodiment.

Other features of the present embodiments will be apparent from the accompanying drawings and from the detailed description that follows.

### DETAILED DESCRIPTION

Methods and systems of earpiece based binaural sound capturing and playback are disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

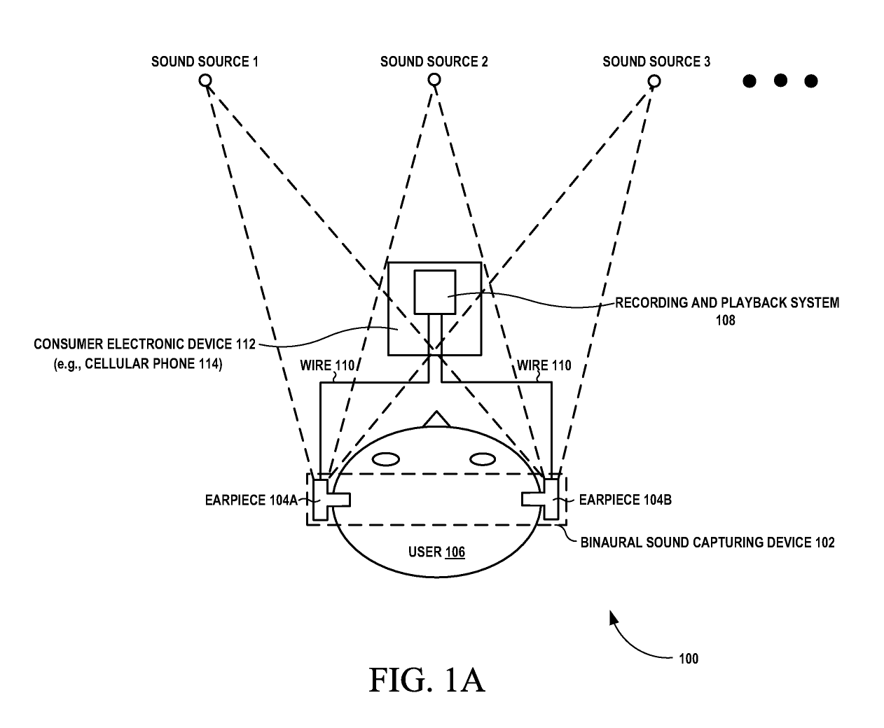

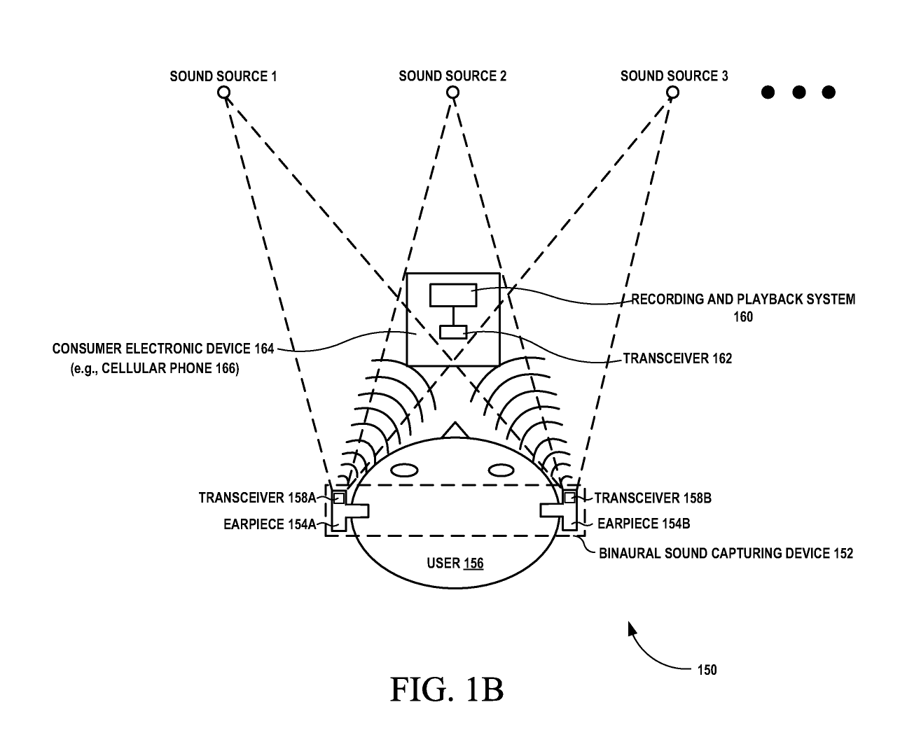

FIG. 1A illustrates a schematic diagram 100 of an exemplary binaural sound capturing device 102 communicating with a recording and playback system 108 via a wire 110, according to one embodiment. As shown in FIG. 1A, the binaural sound capturing device 102 includes two earpieces 104A and 104B (e.g., ear plugged earphones for a left ear and a right ear, respectively) for a user 106. In one embodiment, each of the two earpieces 104A and 104B includes a housing, a speaker and a microphone.

In one exemplary implementation, the binaural sound capturing device 102 is coupled to the recording and playback device 108 via the wire 110. It is appreciated that the recording and playback system 108 is embedded in a consumer electronic device 112. For example, the consumer electronic device 112 includes a cellular phone 114, an MP3 player, an ipod, etc.

In operation, the binaural sound capturing device 102 captures sound reaching the right ear and the left ear of the user 106 through the earpieces 104A and 104B. For example, the sound may reach the user's ears from a sound source 1, a sound source 2 and/or a sound source 3 as shown in FIG. 1A. In one embodiment, the binaural sound capturing device 102 converts the sound received by outer ears to electrical data. In this embodiment, the electrical data is transmitted via the wire 110 to the recording and playback system 108. In one exemplary implementation, an external storage device embedded in the consumer electronic device 112 stores the binaurally captured sound, and the user can experience the 3-D sound effect of the stored data by listening it with the earpieces 104A and 104B or their equivalents.

FIG. 1B illustrates a schematic diagram 150 of an exemplary binaural sound capturing device 152 wirelessly communicating with a recording and playback system 160, according to one embodiment. As shown in FIG. 1B, the binaural sound capturing device 152 includes two earpieces 154A and 154B (e.g., ear plugged earphones for a left ear and a right ear, respectively) for a user 156. In one embodiment, each of the two earpieces 154A and 154B includes a housing, a speaker and a microphone.

As shown in FIG. 1B, the binaural sound capturing device 152 is wirelessly coupled to the recording and playback system 160. Further, as shown in FIG. 1B, the earpieces 154A and 154B include transceivers 158A and 158B respectively. Also, as shown in FIG. 1B, the recording and playback system 160 includes a transceiver 162. It is appreciated that the recording and playback system 160 is embedded in a consumer electronic device 164. For example, the consumer electronic device 164 may be a cellular phone 166, an MP3 player, an ipod, etc.

In operation, the binaural sound capturing device 152 captures sound reaching the right ear and the left ear of the user 156 through the earpieces 154A and 154B. For example, the sound may reach the user's ears from a sound source 1, a sound source 2 and/or a sound source 3 as shown in FIG. 1B. In one embodiment, the binaural sound capturing device 152 converts the sound received by outer ears to electrical data. In this embodiment, the transceivers 158A and 158B of the binaural sound capturing device 152 wirelessly communicates the electrical data to the transceiver 162 of the recording and playback system 160. In one exemplary implementation, an external storage device embedded in the consumer electronic device 164 stores the binaurally captured sound for a playback of the electrical data with a binaural effect if the user were to listen with the earpieces 154A and 154B or their equivalents.

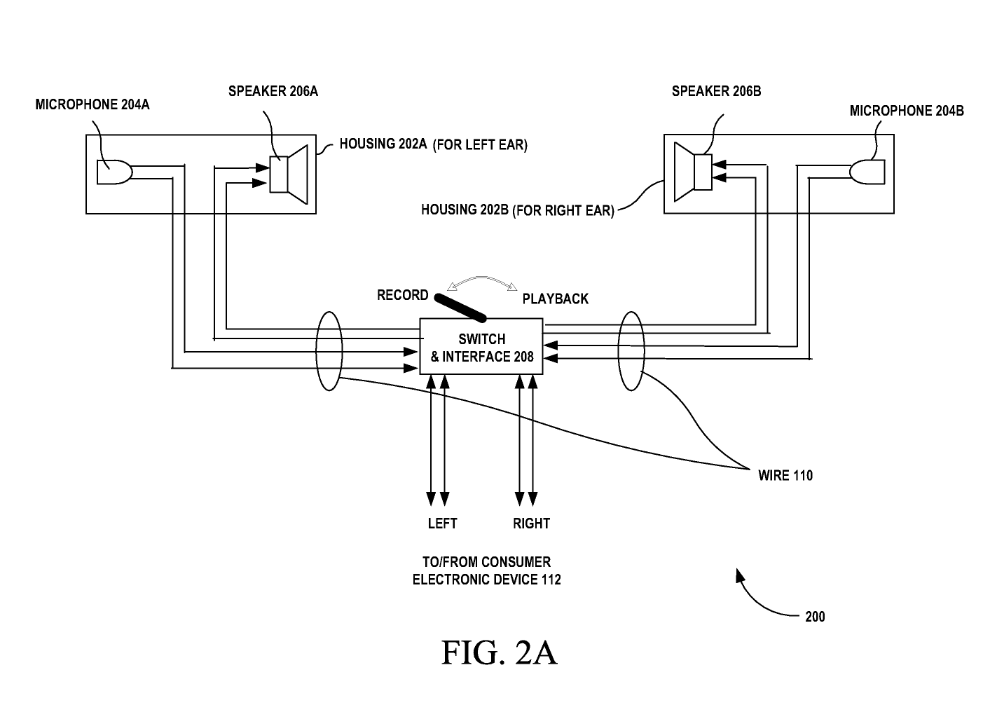

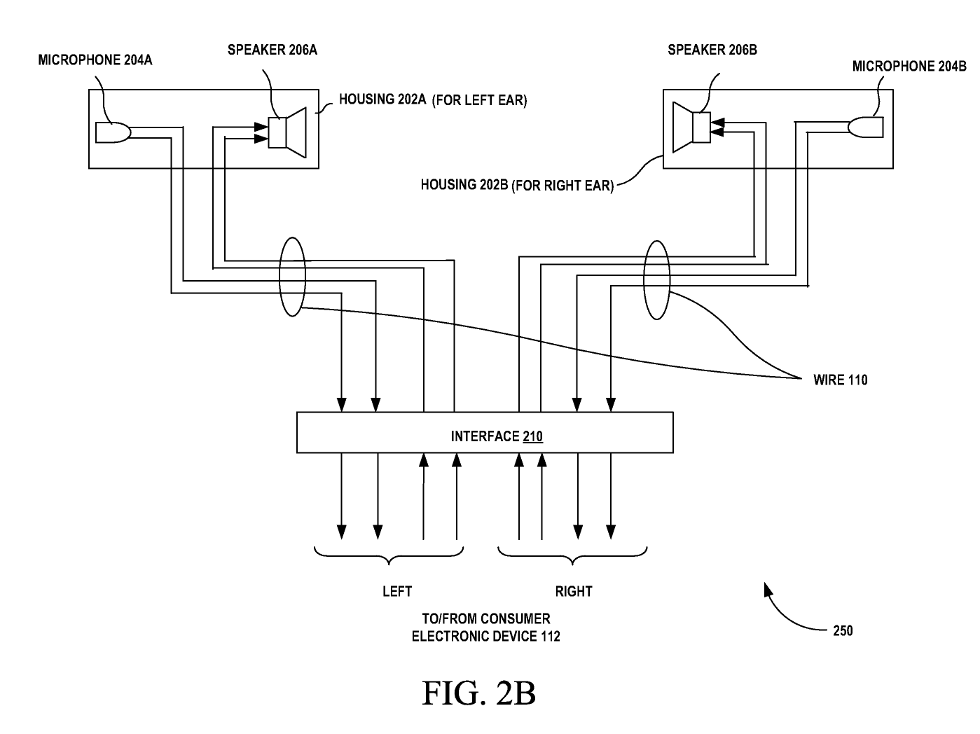

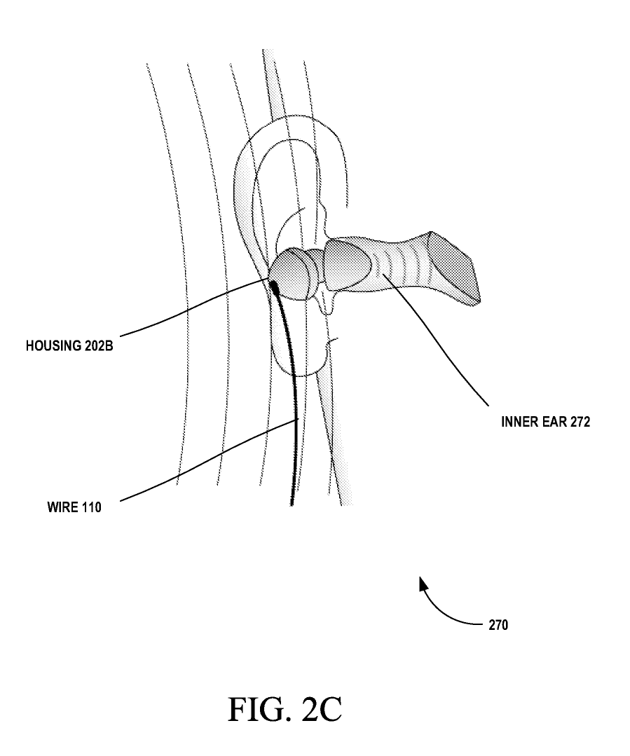

FIG. 2A is a block diagram of an exemplary binaural sound capturing device 200, according to one embodiment. As shown in FIG. 2A, the device 200 includes housings 202A and 202B, microphones 204A and 204B, speakers 206A and 206B and a switch and interface 208. It is appreciated that the two earpieces of the binaural sound capturing device 200 is exemplary embodiments of the earpieces 104A and 104B of FIG. 1A, respectively. In one exemplary implementation, the speakers 206A and 206B are embedded in the housings 202A and 202B, respectively, facing an inner ear of the user 106, and the microphones 204A and 204B are embedded in the housing 202 at an outer ear of the user 106. In one embodiment, the microphones 204A and 204B convert binaural a sound or sounds received by the outer ear (e.g., the entrance to the ear canal) to electrical data.

Further, the electrical data are stored to an external storage device (not shown in figure) for a playback of the electrical data. In one embodiment, the playback of the electrical data is performed via the speakers 206A and 206B. Further, as shown in FIG. 2A, the microphones 204A and 204B and the speakers 206A and 206B are coupled to the external storage device (e.g., embedded in the consumer electronic device 112) using the wire 110.

In one exemplary implementation, the wire 110 is based on a two wire interface for operating either the microphones 204A and 204B or the speakers 206A and 206B at any particular time using the switch and interface 208. Thus, the binaural sound capturing device 200 can be toggled between the recording mode and the playback mode using the switch. Further, although not shown, the microphones 204A and 204B and the speakers 206A and 206B may be coupled to the external storage device (e.g., embedded in the consumer electronic device 164) wirelessly. In one exemplary implementation, transceivers may be embedded in the housings 202A and 202B wirelessly to wirelessly communicate the binaurally captured sound (e.g., which is converted to electrical data) to the external storage device. In one embodiment, switches may be embedded in the housing 202A and 202B to control a connection between the microphones 204A and 204B and the external storage device.

In another exemplary implementation, as illustrated in FIG. 2B, the binaural sound capturing device 250 may be coupled with the external storage device of the consumer electronic device 112 using a four wire interface for simultaneously operating both the microphones 204A and 204B and the speakers 206A and 206B. In one embodiment, either the recording mode using the microphones 204A and 204B or the playback mode using the speakers 206A and 206B may be activated using a switch embedded in the consumer electronic device 112.

FIG. 2C illustrates an exemplary earpiece of the binaural sound capturing device 200 or the binaural sound capturing device 250 worn by a user, according to one embodiment. As illustrated in FIG. 2C, the earpiece or the housing 202B of the earpiece worn in the right ear of the user is small enough to fit inside the ear of the user. This may allow the microphone (which is not shown) of the earpiece to capture sound with a binaural effect when it is combined with the microphone of the earpiece worn in the left ear of the user. Additionally, the earpieces can be used to listen to the recording when the captured sound is played back, thus providing the user with the 3D-effect of the captured sound.

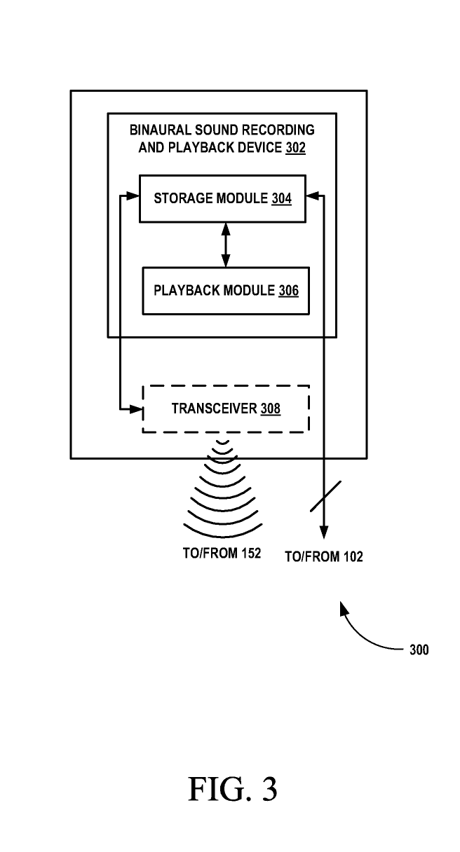

FIG. 3 is a block diagram 300 of an exemplary recording and playback system 302, according to one embodiment. It is appreciated that the recording and playback system 302 is an exemplary embodiment of the recording and playback devices 108 and 160 of FIG. 1A and FIG. 1B, respectively. As shown in FIG. 3, the recording and playback system 302 includes a storage module 304 and a playback module 306.

In one embodiment, the storage module 304 records the electrical data captured by the binaural sound capturing device 102. In another embodiment, the storage module 304 records electrical data captured by the binaural sound capturing device 152. In one exemplary implementation, the binaural sound capturing devices 102 and 152 include two earpieces (e.g., the earpieces 104A and 104B, and the earpieces 154A and 154B of FIG. 1A and FIG. 1B, respectively) for a user (e.g., the user 106 or the user 156) for converting binaural sound received by outer ears of the user to the electrical data.

In one embodiment, the each of the two earpieces includes a wire (e.g., the wire 110 of FIG. 1A) coupled to the storage module 304 for communicating the electrical data to the external storage device. In another embodiment, the each of the two earpieces wirelessly communicates the electrical data to the external storage device via a transceiver 308. It is appreciated that the transceiver 308 is an exemplary embodiment of the transceiver 162 of FIG. 1B.

Furthermore, the playback module 306 plays back the electrical data. In one embodiment, the playing back the electrical data includes processing the electrical data via the speaker (e.g., the speakers 206A and 206B of FIG. 2A and FIG. 2B, respectively) the each of the two earpieces. In another embodiment, the playing back the electrical data includes fast forwarding the electrical data. In yet another embodiment, the playing back the electrical data includes rewinding the electrical data.

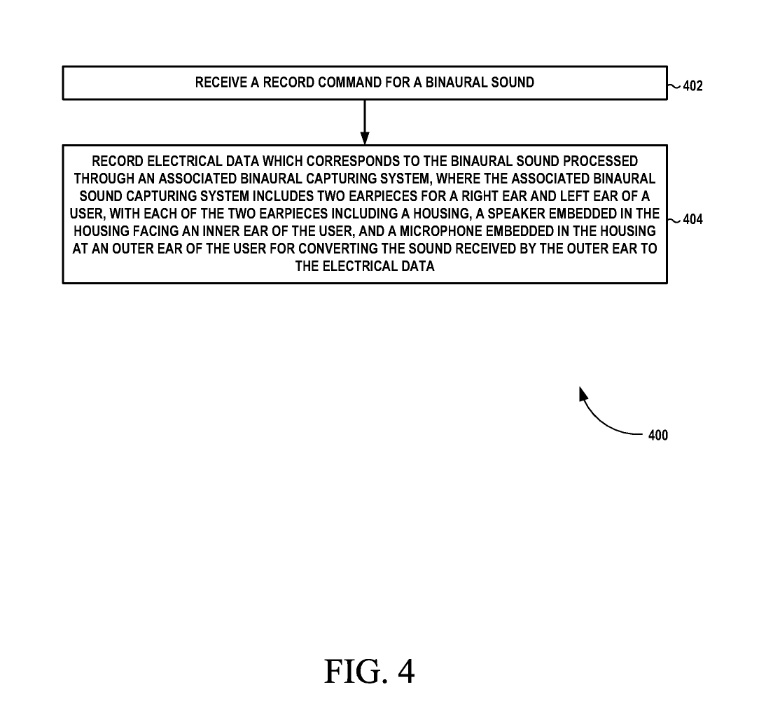

FIG. 4 is a process flow chart of an exemplary method 400 for storing a binaural sound captured by a binaural sound capturing device, according to one embodiment. In one embodiment, the method 400 illustrates recording and playing back the binaural sound. In step 402, a record command for a binaural sound is received. In step 404, electrical data which correspond to the binaural sound processed through an associated binaural sound capturing device are recorded. In one example embodiment, the associated binaural sound capturing device includes two earpieces for a right ear and a left ear for a user.

Each of the two earpieces may include a housing, a speaker embedded in the housing facing an inner ear of the user, and a microphone embedded in the housing at an outer ear of the user for converting the binaural sound received by the start of the user's ear canal to the electrical data. Further, the electrical data is played back (e.g., via a speaker) in response to a playback command. Moreover, the method may be in a form of a machine-readable medium embodying a set of instructions that, when executed by a machine, cause the machine to perform the method of FIG. 4.

The above-described method and/or system provide(s) a three dimensional audio recording into any cellular phone or any entertainment device having stereo recording capability through use of earpieces. Further, the above-described binaural recording technique enables a user to play back the recorded binaural sound through the earpieces such that, the user experiences a same sound quality.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated circuit (ASIC)).

What is claimed is:

1. A binaural sound capturing device, comprising:
two earpieces for a right ear and a left ear for a user, with each of the two earpieces comprising:
a housing;
a speaker embedded in the housing facing an inner ear of the user; and
a microphone embedded in the housing at an ear canal of the user for converting a sound received by the ear canal to electrical data, wherein the electrical data are stored to an external storage device for a playback of the electrical data with a binaural effect.

2. The device of claim 1, wherein the external storage device is embedded in a consumer electronic device.

3. The device of claim 2, wherein the consumer electronic device comprises a cellular phone.

4. The device of claim 1, wherein the microphone and the speaker are coupled to the external storage device using a wire.

5. The device of claim 4, wherein the wire is based on a two wire interface for operating either the speaker or the microphone at a particular time.

6. The device of claim 4, wherein the wire is based on a four wire interface for simultaneously operating both the speaker and the microphone.

7. The device of claim 1, wherein the microphone and the speaker are coupled to the external storage device wirelessly.

8. The device of claim 7, further comprising a transceiver embedded in the housing for transmitting the electrical data to the external storage device.

9. The system of claim 1, further comprising a switch embedded in the housing to control a connection between the microphone and the external storage device.

10. The device of claim 1, wherein the playback of the electrical data is performed via the speaker in the each of the two earpieces.

11. A binaural sound recording and playback system, comprising:
a storage module for recording electrical data captured by a binaural sound capturing device; and
a playback module for playing back the electrical data, wherein the binaural sound capturing device comprises:
two earpieces for a right ear and a left ear for a user, with each of the two earpieces comprising:
a housing;
a speaker embedded in the housing facing an inner ear of the user; and
a microphone embedded in the housing at an outer ear of the user for converting a sound received by the outer ear to the electrical data.

12. The system of claim 11, wherein the each of the two earpieces further comprises a wire coupled to the storage module for communicating the electrical data.

13. The system of claim 11, wherein the each of the two earpieces further comprises a transceiver for wirelessly communicating the electrical data to the external storage device.

14. The system of claim 11, wherein the playing back the electrical data comprises processing the electrical data via the speaker of the each of the two earpieces.

15. The system of claim 11, wherein the playing back the electrical data comprises fast forwarding the electrical data.

16. The system of claim 11, wherein the playing back the electrical data comprises rewinding the electrical data.

17. A method for recording and playback of a binaural sound, comprising:
receiving a record command for the binaural sound; and
recording electrical data which correspond to the binaural sound captured through an associated binaural sound capturing system, wherein the associated binaural sound capturing device comprises:
two earpieces for a right ear and a left ear for a user, with each of the two earpieces comprising:
a housing;
a speaker embedded in the housing facing an inner ear of the user; and
a microphone embedded in the housing at an outer ear of the user for converting the binaural sound received by the outer ear to the electrical data.

18. The method of claim 17, further comprising playing back the electrical data in response to a playback command.

19. The method of claim 18, wherein the playing back the electrical data is performed via the speaker.

20. The method of claim 17 in a form of a machine-readable medium embodying a set of instructions that, when executed by a machine, causes the machine to perform the method of claim 17.
